(19) United States
(12) Patent Application Publication
(10) Pub. No.: US 2008/0219285 A1
(43) Pub. Date: Sep. 11, 2008

(54) Multi-Channel Communications Protocol

(75) Inventors: Peter Key, Cambridge (GB); Ayalvadi Ganesh, Cambridge (GB); Ashvin Lakshmikantha, Urbana, IL (US)

Correspondence Address: LEE & HAYES PLLC, 421 W RIVERSIDE AVENUE SUITE 500, SPOKANE, WA, 99201, US

(73) Assignee: Microsoft Corporation, Redmond, WA (US)

(21) Appl. No.: 11/683,861

(22) Filed: Mar. 8, 2007

(51) Int. Cl. H04L 12/413

(52) U.S. Cl. 370/445

(57) ABSTRACT

There is a need to improve design of communications protocols in which two or more channels are provided and, optionally, in which collision avoidance is not available. An improved protocol is provided in which communications nodes pick a channel on which to transmit and collisions may occur where two nodes attempt to transmit on the same channel. The node currently occupying a channel is arranged to have a specified probability of holding onto that channel as compared to a newcomer. Other methods are described whereby a node is able to occupy more than one channel at the same time and whereby nodes each occupy approximately the same number of channels.

### BACKGROUND

There is increasing demand for communications capacity in communications networks of all types with the need for higher end-to-end throughput and reduced data transfer times. However, it is expensive and time consuming to install additional communications network equipment in order to increase capacity. Thus there is a need to improve the efficiency with which existing bandwidth is used, for example, by improving the design of communications protocols used to communicate data over the network.

Communications protocols are typically provided in layers in the communications network; that is, a protocol stack approach is typically used. For example, at a high level these layers begin with a physical layer interfacing with the network infrastructure, usually followed by a data link layer, a transport layer, a network layer and an application layer. Within the data link layer a medium access control (MAC) layer is typically provided which may for example, control access to the physical transmission medium on a communications network such as a local area network (LAN) or other type of communications network.

In packet-based communications networks data is inserted into units referred to as packets which are transmitted across the network according to the communications protocols being used.

Most existing communications systems having a MAC layer typically use a single channel approach at this layer. However, more recently, the use of multi-channels at the MAC layer has been investigated. These multiple channels may be realised as either physical channels or orthogonal logical channels provided that they enable simultaneous data transmission.

### SUMMARY

The following presents a simplified summary of the disclosure in order to provide a basic understanding to the reader. This summary is not an extensive overview of the disclosure and it does not identify key/critical elements of the invention or delineate the scope of the invention. Its sole purpose is to present some concepts disclosed herein in a simplified form as a prelude to the more detailed description that is presented later.

There is a need to improve design of communications protocols in which two or more channels are provided and, optionally, in which collision avoidance is not available. An improved protocol is provided in which communications nodes pick a channel on which to transmit and collisions may occur where two nodes attempt to transmit on the same channel. The node currently occupying a channel is arranged to have a specified probability of holding onto that channel as compared to a newcomer. Other methods are described whereby a node is able to occupy more than one channel at the same time and whereby nodes each occupy approximately the same number of channels.

Many of the attendant features will be more readily appreciated as the same becomes better understood by reference to the following detailed description considered in connection with the accompanying drawings.

### DESCRIPTION OF THE DRAWINGS

The present description will be better understood from the following detailed description read in light of the accompanying drawings, wherein:

FIG. 1 is a schematic diagram of a communications network;

FIG. 2 is a flow diagram of an example method of selecting a channel and transmitting data packets on that channel;

FIG. 3 is a flow diagram of an example method of selecting a plurality of channels and transmitting data packets on those channels;

FIG. 4 is a flow diagram of another example method of selecting a plurality of channel and transmitting data packets on those channels;

FIG. 5 is a schematic diagram of another communications network;

FIG. 6 is a schematic diagram of a communications network node;

FIG. 7 illustrates an exemplary computing-based device in which embodiments of methods of selecting channels and transmitting data packets may be implemented.

Like reference numerals are used to designate like parts in the accompanying drawings.

### DETAILED DESCRIPTION

The detailed description provided below in connection with the appended drawings is intended as a description of the present examples and is not intended to represent the only forms in which the present example may be constructed or utilized. The description sets forth the functions of the example and the sequence of steps for constructing and operating the example. However, the same or equivalent functions and sequences may be accomplished by different examples.

Although the present examples are described and illustrated herein as being implemented in a wireless access communications network, the methods described are provided as an example and not a limitation. As those skilled in the art will appreciate, the present examples are suitable for application in a variety of different types of communications network.

The methods described herein are intended to implemented as part of communications protocols in which two or more channels are provided (see below for more discussion about the term channel) and, optionally, in which collision avoidance is not available. Collision avoidance involves active sensing or probing to determine whether a particular channel is busy or is available for use. This process demands additional resources. In the methods described herein, such active sensing or probing for collision avoidance is unavailable. For example, collision avoidance is typically unavailable to communications protocols used at the MAC layer in wireless access communications networks. However, this is just one example. There are many communications protocols at different layers where collision avoidance is unavailable or not desired. For example, this is typically the case in optical wavelength division multiplexed networks. The methods described herein give good benefits when used with communications protocols which do not provide collision avoidance. Having said that, some benefits are also achieved when the methods are used with communications protocols which do provide collision avoidance.

### An Exemplary System

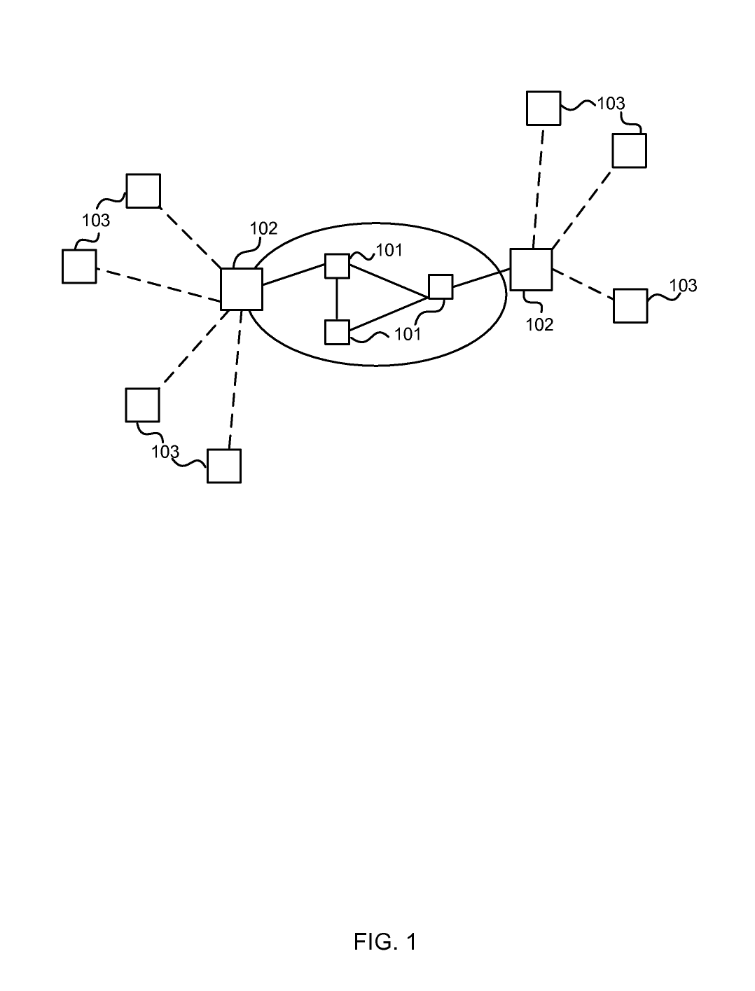

FIG. 1 is a schematic diagram of a communications network in which the communications protocols described herein may be implemented. It comprises a plurality of communications terminals 103 which are in wireless communication with base stations 102 of communications network 100. The communications terminals are of any suitable type such as mobile telephones, laptop computers, personal digital assistants and the like. The communications network 100 comprises nodes 101 that are interconnected using communications links of any suitable type such as physical links or wireless links. The communications network of FIG. 1 may comprise many more communications terminals 103, base stations 102 and nodes 101 than are illustrated in the diagram for reasons of clarity.

Communication between the communications terminals 103 and the base stations 102 is achieved using any suitable communications protocols as known in the art together with particular protocols as described herein. For example, the protocols described herein may be implemented at one layer in a protocol stack where the stack comprises other protocols. Also, the protocols described herein may be implemented by taking an existing communications protocol and modifying it to meet the communications protocol requirements described herein. For example, the existing communications protocol may be the widely used IEEE 802.11 wireless MAC protocol. However, this is not essential, any suitable communications protocol may be used.

Various different example methods are now described for an improved multi-channel MAC protocol. Each of these methods involves providing a plurality of channels for communication in the MAC layer and each method is described with respect to an uplink scenario in which communications terminals 103 are attempting to transfer data to a base station 102. However, the invention is not limited to uplink situations; an example for a downlink situation is described later. Also, the invention is not limited to MAC layer communications protocols.

The number of channels provided may be greater than the number of communications terminals (also referred to herein as users) seeking to communicate with a given base station. For example the number of communications channels may be two or more times the number of communications terminals 103 associated with a particular base station. However, this is not essential. It is also possible to use fewer communications channels than there are communications terminals.

The communications channels may be provided in any suitable manner. For example, these may be provided using frequency division; that is by using different frequency bands that are available for simultaneous data transmission. Another option is to provide the channels using a slotted approach such as using time division multiplexing or code division multiplexing or combinations of time and code division multiplexing. Combinations of frequency division and time division and/or code division multiplexing may also be used, for example as in orthogonal-frequency division multiplexing (OFDM). OFDM is described in detail in Tse and Viswanath “Fundamentals of Wireless Communication” Cambridge University Press, 2005.

Under time division multiplexing, a larger time period called a frame is divided into a fixed number of mini-slots. Each communications terminal picks a particular mini-slot and transmits data only in that mini-slot. Thus the transmissions of these communications terminals may be separately identified and are effectively transmitted on different channels. Time division multiplexing is described in “Data Networks” second edition, 1991, Bertselkas and Gallager ISBN-10:0132009161.

Under code division multiplexing each communications terminal employs a unique pseudo-noise sequence (PN) and transmits data by spreading the signal (data) over a much larger bandwidth using the PN sequence. By knowing the spreading sequences, a receiver is able to decode data from all the communications terminals even when multiple communications terminals transmit at the same time. Each PN sequence or code can be thought of as a separate channel for data transmission. Code division multiplexing is described in more detail in Bertossi and Bonuccelli “Code assignment for hidden terminal interference avoidance in multihop packet radio networks.” IEEE Transactions on communications, 3(4):441449, August 1995. Code division multiplexing may also be deployed in ad hoc networks as described in Muqattash and Marwan “CDMA based mac protocol for wireless ad hoc networks.” In proceedings of the International Symposium on Mobile Ad Hoc Networking and Computing (MOBIHOC03), page 153163, June 2003.

### Exemplary Method

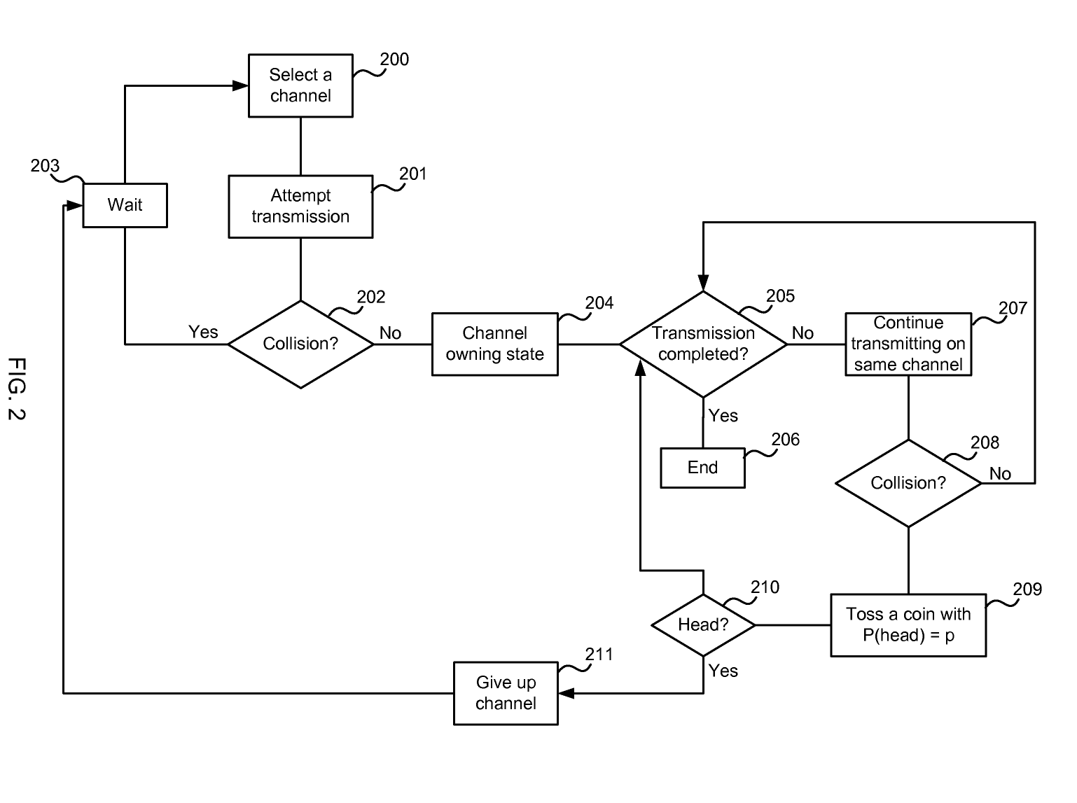

A first example method for an improved multi-channel MAC protocol is now described with reference to FIG. 2. This method may be carried out independently at a plurality of nodes in a communications network, such as the communications terminals 103 of FIG. 1. Each communications terminal 103 has an amount of data that it requires to transmit to a base station 102 (which may also be referred to as an access point of communications network 100). This amount of data may be a single data file or other piece of data of any suitable type. The data is formed into packets in any suitable manner as known in the art and according to the type of mechanism being used to provide channels. The transmission of a collection of packets of data by a communications terminal 103 on a particular channel and for a particular data file or other piece of data is referred to as a flow of packets.

Previously, MAC protocols have been optimized for the transmission of single data packets rather than flows of data packets. That is, the notion of a flow or a collection of data packets does not typically exist in the MAC layer, but only at higher layers such as the transport, network or application layers. However, it is recognized here that most data transfers or exchanges of information are flow based and this is made use of in the methods described herein.

The method of FIG. 2 is now described as an example method carried out at a communications terminal 103 seeking to upload a data file or other piece of data to a base station 102 or other communications network node. This method may be carried out at any of the communications terminals 103 concurrently but is now described for a single communications terminal 103 for clarity. The communications terminal 103 selects (block 200) a channel on which to transmit its flow of packets into which the data file has been divided. This selection may be made at random or using a pseudo random algorithm or in any other suitable manner. The selection is made without any knowledge about the current state of those channels, for example, as to whether those channels are already busy or are idle.

The communications terminal 103 attempts to transmit a packet on the selected channel (block 201) and makes an assessment as to whether a collision has occurred or not. If the communications terminal 103 receives an acknowledgement message (ACK message) associated with the transmitted packet within a specified time limit, then it is assumed that no collision has occurred. This type of ACK message is referred to herein as a first ACK message in order to distinguish it from other ACK messages received later in the process. In this case the communications terminal 103 moves to a channel owning state (block 204) in which it continues to transmit packets of its flow on the selected channel with a certain degree of persistence. This degree of persistence, or “stickiness” is adjustable by adjusting a parameter value as is described in more detail below.

The specified time limit for assessing whether a collision has taken place is referred to herein as a time slot. The length of a time slot is sufficient for a communication terminal to transmit a single packet to the base station and to receive an acknowledgement from the base station 102. In an example implementation, its length is the same at all communication terminals 103 and is specified depending on the intended application scenario. For example, in a wireless local area network (WLAN), it depends on the bandwidth per channel, the maximum packet size and the maximum transmission range (or maximum distance between nodes). In practice, these values are estimated or calculated in advance using test packets, or are continuously monitored during the method itself or obtained in any other suitable manner.

If no ACK message is received during the specified time, a collision is assumed to have occurred. For example, if the selected channel was already busy, both the attempted transmission packet and the packet on the already busy channel are likely to be dropped. In this situation, the communication terminal 103 waits (block 203) for a specified time before repeating the steps of selecting a channel (block 200) and attempting to transmit on that channel (block 201). The specified waiting time may be a random time such as a random (or pseudo random) integer multiple of time slots. If the waiting time were zero or fixed, then the communications terminal 103 may experience repeated collisions at block 202.

In one embodiment the random waiting time at block 203 comprises a process which decides, at the expiration of each time slot, to exit the waiting stage with probability α which may be adjustable. For lightly loaded networks with a load less than about 50% the value of the channel release probability P may be set at about p=0.1 and the channel selection attempt probability α set at about α=0.5. In the case of moderately loaded networks with a load of about 75% p may be set at p=0.05 and α at α=0.2. This probability α is referred to herein as a channel selection attempt probability.

As mentioned above, once the communications terminal 103 has entered a channel owning state 204 it continues to transmit packets of its flow on the selected channel with a certain degree of persistence. It monitors whether the transmission of the flow or collection of data packets is complete (block 205). For example, the packets of a flow may be marked with a flow identifier such that it is possible to detect when the transmission of that flow is complete. Alternatively, the point when transmission is complete may be detected by simply noting when there are no more packets to transmit over a specified time period. Any other suitable method for determining when transmission is complete may be used. Once transmission is complete the process ends (block 206) as the whole data file has been transmitted. Otherwise the communications terminal continues to transmit packets of its flow on the selected channel (block 207) until a collision is assumed to have occurred (block 208). For example, a collision might occur if another communications terminal 103 attempts to transmit on the same channel.

A collision is assumed to have occurred if no ACK is received in the specified time, in the same manner as at block 202. This type of ACK message is referred to herein as a second ACK message in order to distinguish it from the ACK messages received at block 202. If a collision is assumed to have occurred the communications channel gives up the selected channel (block 211) with probability p (block 209 and block 210). This probability p may be adjusted in order to adjust the degree of “stickiness” or persistence mentioned above. The term “channel release probability” is used to refer to this probability value p in order to distinguish it from the channel selection attempt probability α.

Any suitable value of probability p may be used. For example, if p=1, flows are persistent until they suffer a collision, at which point they always back off. In another example, if p=0 then channel capture occurs where a communications terminal 103, once it enters a channel owning state, remains in that state until it has completed its transmission. This may be a workable situation where the number of channels is typically larger than the number of communications terminals attempting to access the medium at a given time.

In some embodiments the value of the channel release probability p is arranged such that a communications station which has been transmitting successfully on a channel has a high probability of holding onto that channel whilst a newcomer is likely to give up and attempt on a new channel. For example, this is achieved by using a small positive value of the channel release probability p. This may also be expressed as saying that a current occupant of a channel has a much higher probability of holding onto that channel than a newcomer.

Following the method of FIG. 2 it is unlikely that two communications channels ever enter a channel owning state in respect of the same channel simultaneously. This is because a collision would occur at block 202. In the extremely unlikely event that more than one communications station 103 thinks it owns the same channel at the same time, then a positive channel release probability at block 209 will allow one or both channels to relinquish ownership. For example, channel errors or interference between channels could in rare cases cause two communications stations 103 to think that they own the same channel at the same time. Therefore in some embodiments of the invention a small positive value for the channel release probability p is used.

The method described above with reference to FIG. 2 may also be considered in an example as involving flows in one of two classes. Each flow, when it arrives into the system, picks a channel at random and attempts transmission on this channel. A distinction is made between flows which are yet to find a channel for transmission and flows which are channel owners. Flows may be in one of 2 classes, satisfied (S) or unsatisfied (U). Each flow enters the system as a class U flow. Each class S flow “owns” a channel, and will attempt to transmit on that channel in each time slot (in the case of a slotted approach being used to provide multiple channels). Each class U user attempts to transmit with channel selection attempt probability α, independently from slot to slot, and chooses a channel at random on which to transmit. If it successfully transmits on that channel, then it turns into a class S user and subsequently owns that channel. If it suffers a collision, it continues to be of class U. When a class S user suffers a collision, it will turn into a class U user with some probability p, independent of everything else.

In this way there is a breaking of symmetry between communications terminals, whereby terminals who have already acquired a channel behave differently from those who have not.

Using the method of FIG. 2 it is possible to provide each communications terminal with a single channel on which to transmit. This maximizes the stability of the system and improves efficient use of the available communications bandwidth. In addition, minimal higher-layer information is required and the protocol is distributed, not requiring any centralized scheduler for example. The delay or transfer time associated with an entire flow of packets may be improved using this method.

### Another Exemplary Method

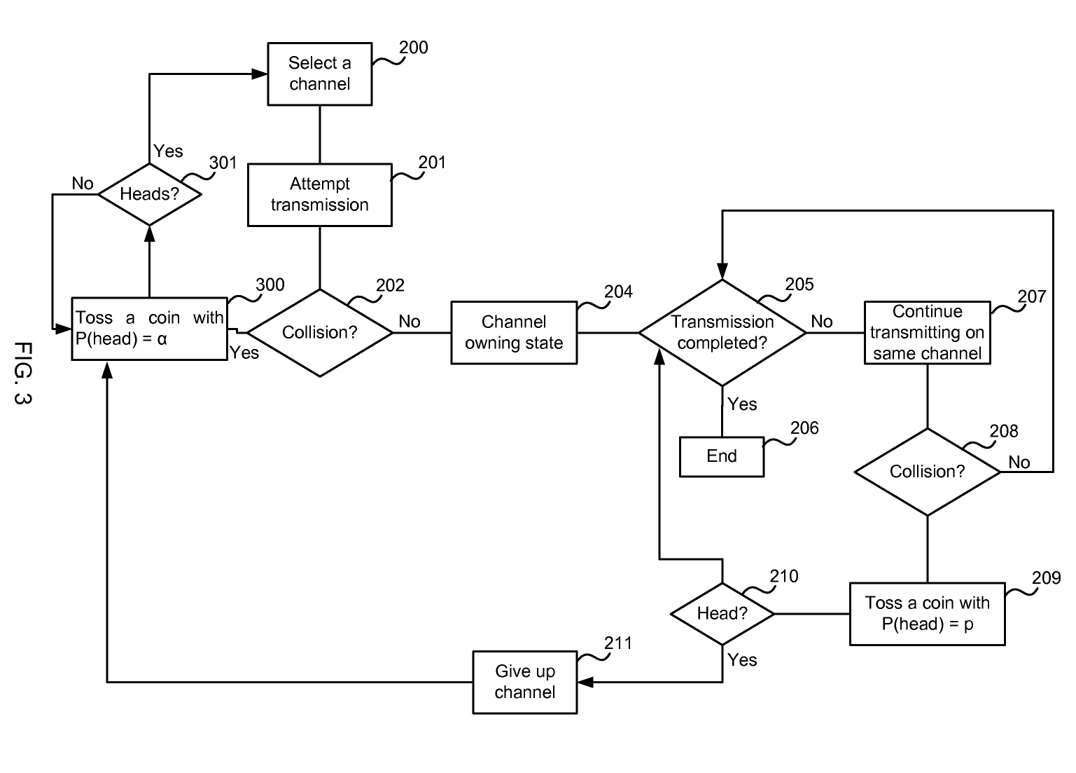

The method described above with reference to FIG. 2 can be thought of as seeking to provide each communications terminal 103 with a single channel on which to transmit. In another embodiment it is required to enable each communications terminal 103 to transmit on more than one channel at the same time. For example, this may be advantageous in situations where there are more communications channels than there are communications terminals 103. This embodiment is now described with reference to FIG. 3.

FIG. 3 is the same as FIG. 2 except that the wait block 203 is shown in more detail as comprising a step of tossing a coin (block 300) with probability of obtaining heads being α (the channel selection attempt probability) and moving to block 200 if heads are obtained. This is an example of a process that may be used to implement the wait block 203 of FIG. 2 as the process of tossing a coin continues until heads are obtained. It is not necessary to toss an actual coin; rather any random process (or pseudo random process) yielding two possible outcomes is used.

FIG. 3 also differs from FIG. 2 in that on entering the channel owning state the communications terminal is also able to follow a loop to concurrently re-enter the equivalent of the wait block 203 of FIG. 2. In this way the communications terminal, is able to enter the channel owning state in respect of a plurality of channels at the same time. For example, suppose that block 202 has been reached and no collision is inferred. The communications terminal proceeds to enter the channel owning state (block 204) and also, at the same time, move to block 300. At block 300 a substantially random selection of two possible outcomes is made and according to the outcome, another channel may be selected at block 200. Transmission is attempted on the selected channel (block 201) and if no collision is inferred the process proceeds to the channel owning state (block 204). In this way the communications terminal is able to enter the channel owning state for more than one channel. Packets from the same data flow may then be sent concurrently using all the channels of the channel owning states in order to make the transmission. This may be more efficient in some situations, especially where there are more channels than communication stations making uploads.

In another example, a method similar to that of FIG. 3 can be described as follows:

In each time slot, each communications terminal attempts to acquire a new channel with probability α (the channel selection attempt probability), by transmitting a packet on a randomly chosen channel. If the transmission is successful, the communications terminal now “owns” the channel; otherwise it give it up. Moreover, for each channel owned by the communications terminal which suffers a collision, the channel is given up with a probability p (the channel release probability), independent of all other channels. An alternative method allows a communications terminal which suffers collisions on k channels to give up exactly kp channels if kp is an integer. Otherwise, the terminal gives up either [kp] or [kp]+1 channels with probabilities chosen to make the mean number of channels kp; here [kp] denotes the integer part of kp.

### Another Example Method

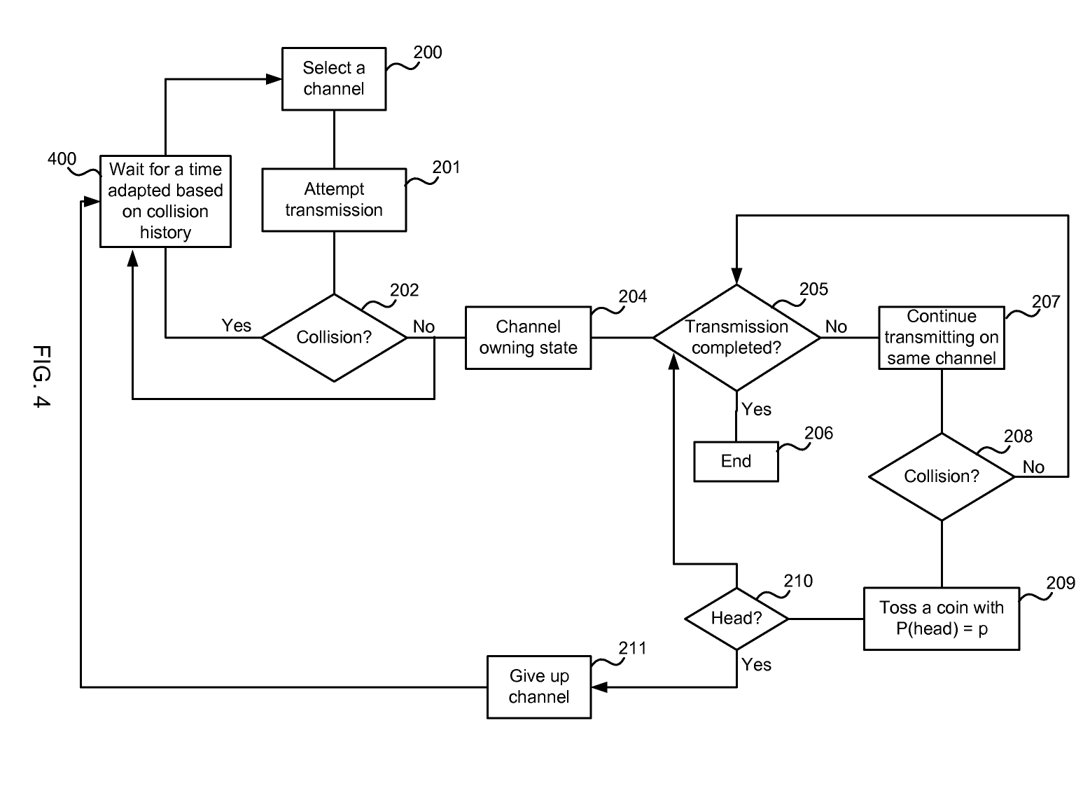

FIG. 4 is also the same as FIG. 3 except that blocks 300 and 301 now become block 400 which represents a process arranged to wait for a time based on collision history. As for the method described with reference to FIG. 3 it is possible for a single communications terminal to enter a channel owning state for more than one channel. In high level terms, the wait process of block 400 is arranged to wait for a short time if no collisions have recently been inferred for transmission of the current data flow. If a collision has recently been inferred, the wait time is increased and if many collisions have recently been inferred the wait time is increased still further. The increase in wait time may be made up to a specified maximum in some examples. The relationship between wait time and history of inferred collisions may be any suitable relationship such as linear, exponential or other as specified. The wait time may be implemented using a random selection of two specified outcomes according to a specified channel selection attempt probability as described above with reference to FIG. 3.

In this way the method of FIG. 4 enables more than one channel to be “owned” at the same time by one communications terminal, but that communications terminal backs off from attempting to own more channels on the basis of history of inferred collisions.

An example of the method of FIG. 4 is now described. Communications terminal i maintains its own value of αᵢ. A new communications terminal i initializes αᵢ to αₘₐₓ. In each time slot, it tries to acquire a new channel with probability αᵢ. If it succeeds, it resets αᵢ to αₘₐₓ and subsequently owns that channel. If the attempt results in a collision, communications terminal i resets αᵢ to αᵢ/2 or αmin, whichever is larger. Also, communications terminal i gives up each channel it owns and on which it suffers a collision with constant probability p, independent of its decisions on other channels.

In the methods of FIGS. 3 and 4 more than one channel may be “owned” at the same time by one communications terminal. These methods may also be arranged to ensure that each communications terminal “owns” an approximately equal number of channels. Alternatively, differentiation may be implemented so that some terminals (say those on a gold service) are able to “own” more channels than those terminals on an economy service.

In the case that the methods described herein are implemented by modifying the standard IEEE 802.11 wireless MAC protocol, the optional RTS/CTS (request to send/clear to send) mechanism which precedes actual packet transmission may be switched off. This would be the preferred implementation if collision avoidance is not possible. However, this is not essential. If the communication nodes 103 are able to implement collision avoidance, the RTS/CTS mechanism can be employed. In this case, a difference with standard IEEE 802.11 is the asymmetry between the terminal that “owns” a channel and a “newcomer”. Whereas in IEEE 802.11, these would have equal probabilities of attempting to access the channel, in the method proposed herein, these probabilities are different in the manner already described.

### Another Exemplary System

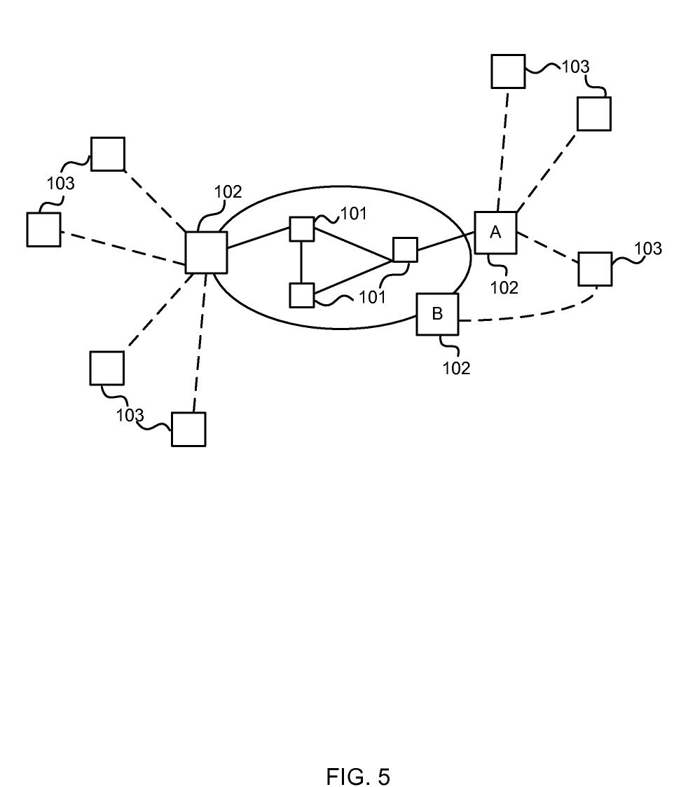

FIG. 5 is a schematic diagram of another communications network in which the methods described herein may be implemented. FIG. 5 is the same as FIG. 1 except that another base station labelled B is shown and another of the base stations 102 is labelled A. Base stations A and B are both able to communicate with the same communications terminal 103 as indicated by dotted lines in FIG. 5.

It is also possible for the methods described herein to be used for downlink scenarios. For example, where the base stations A and B of FIG. 5 require to download flows of packets to the same communications terminal 103. In this case, the base stations A and B each carry out the method of say FIG. 2 in order to transmit packets of a flow to the communications terminal. The base stations may also use the methods of FIGS. 3 and 4 in order to transmit packets of a flow to the communications terminal.

In the methods described herein the choice of the probability values α and p may involve a trade-off between communications link utilization and responsiveness. Responsiveness is an indication of how long it takes for a new flow entering the system to receive a channel. To maximize link utilization generally, α and p are selected as being small. To maximize responsiveness, α and p are generally selected as being large. By selecting non zero and small values of p and α it is possible to achieve both high utilization and satisfactory responsiveness. One aspect of the latter is good short term fairness (where fairness relates to distribution of channels between communications terminals). For example for lightly loaded networks with a load less than about 50% the value of the channel release probability p may be set at about p=0.1 and the channel selection attempt probability α set at about α=0.5. In the case of moderately loaded networks with a load of about 75% p may be set at p=0.05 and α at α=0.2.

### Exemplary Communications Network Node

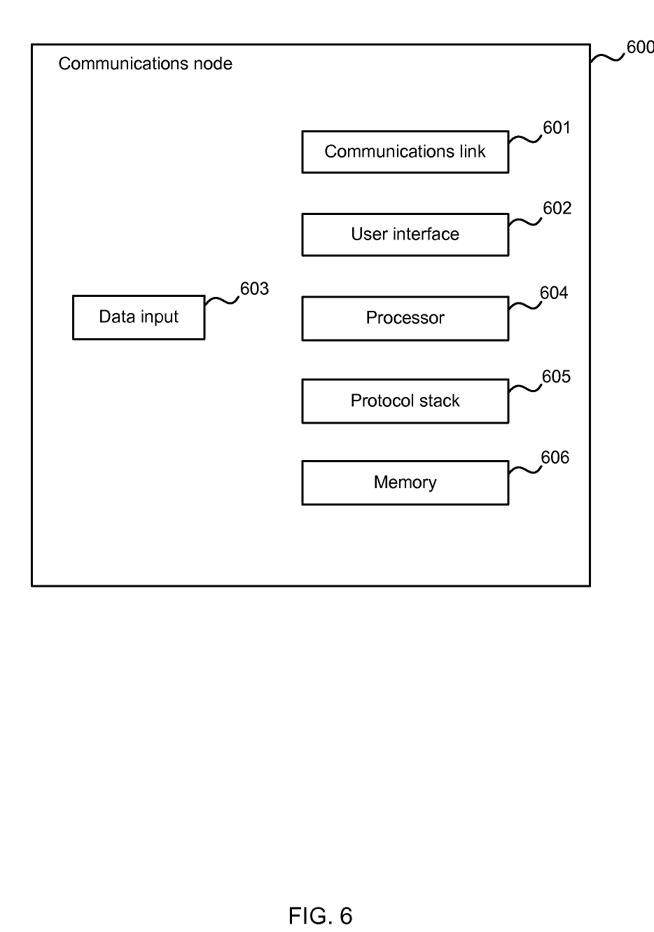

FIG. 6 is a schematic diagram of a communications network node 600 suitable for implementing the methods described herein. For example, the communications network node may be a communications terminal such as a mobile telephone, personal digital assistant, laptop computer, PC or the like. It may also be a base station or other network node in a communications network. It comprises a communications link 601 which is arranged to connect to a communications network in any suitable manner, for example, using a wireless link or physical link. The communications network node may comprise other components not illustrated here for reasons of clarity as known to be provided in conventional communications terminals, base stations and the like.

The communications network node 600 also comprises a user interface 602 which may be a keypad and display screen or any other suitable type of user interface. A processor is provided 604 of any suitable type such as a microprocessor, computer or other processor. A data input 603 is provided to enable data files or other information to be transmitted to be input to the node 600. A protocol stack 605 is shown to indicate that the node is arranged to operate a communications protocol suite and a memory 606 of any suitable type is also provided.

### Exemplary Computing-Based Device

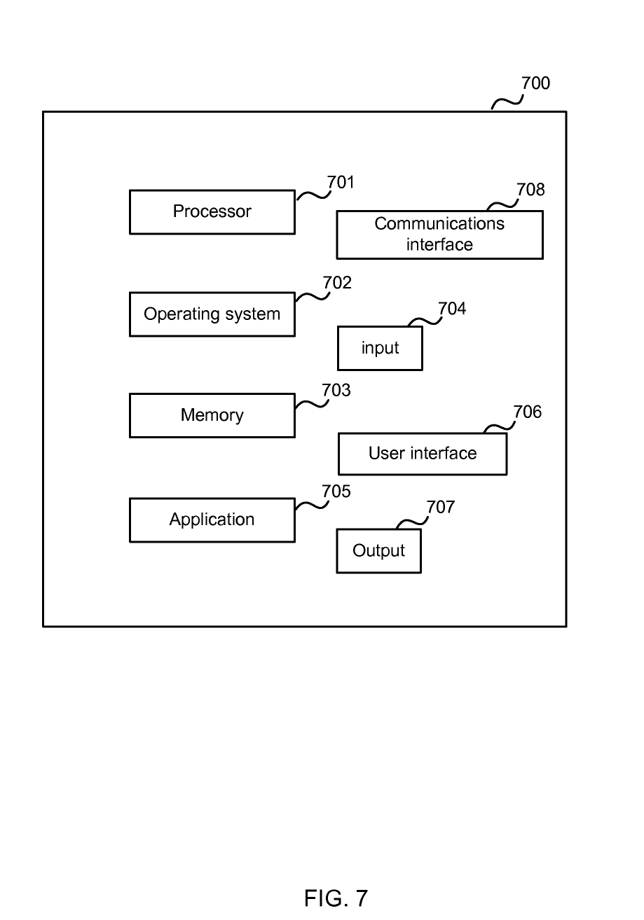

FIG. 7 illustrates various components of an exemplary computing-based device 700 which may be implemented as any form of a computing and/or electronic device, and in which embodiments of the communications network nodes of the present invention may be implemented.

The computing-based device 700 comprises one or more inputs 704 which are of any suitable type for receiving media content, Internet Protocol (IP) input, data files, images or other input. The device also comprises communication interface 708 for interfacing to a communications network of any suitable type. For example, a wireless access communications network, the Internet, or any packet based communications network.

Computing-based device 700 also comprises one or more processors 701 which may be microprocessors, controllers or any other suitable type of processors for processing computing executable instructions to control the operation of the device in order to select communications channels and transmit packets according to specified communications protocols. Platform software comprising an operating system 702 or any other suitable platform software may be provided at the computing-based device to enable application software 705 to be executed on the device.

The computer executable instructions may be provided using any computer-readable media, such as memory 703. The memory is of any suitable type such as random access memory (RAM), a disk storage device of any type such as a magnetic or optical storage device, a hard disk drive, or a CD, DVD or other disc drive. Flash memory, EPROM or EEPROM may also be used.

An output 707 is also provided such as an audio and/or video output to a display system integral with or in communication with the computing-based device. The display system may provide a graphical user interface, or other user interface 706 of any suitable type although this is not essential.

The term ‘computer’ is used herein to refer to any device with processing capability such that it can execute instructions. Those skilled in the art will realize that such processing capabilities are incorporated into many different devices and therefore the term ‘computer’ includes PCs, servers, mobile telephones, personal digital assistants and many other devices.

The methods described herein may be performed by software in machine readable form on a storage medium. The software can be suitable for execution on a parallel processor or a serial processor such that the method steps may be carried out in any suitable order, or simultaneously.

This acknowledges that software can be a valuable, separately tradable commodity. It is intended to encompass software, which runs on or controls “dumb” or standard hardware, to carry out the desired functions. It is also intended to encompass software which “describes” or defines the configuration of hardware, such as HDL (hardware description language) software, as is used for designing silicon chips, or for configuring universal programmable chips, to carry out desired functions.

Those skilled in the art will realize that storage devices utilized to store program instructions can be distributed across a network. For example, a remote computer may store an example of the process described as software. A local or terminal computer may access the remote computer and download a part or all of the software to run the program. Alternatively, the local computer may download pieces of the software as needed, or execute some software instructions at the local terminal and some at the remote computer (or computer network). Those skilled in the art will also realize that by utilizing conventional techniques known to those skilled in the art that all, or a portion of the software instructions may be carried out by a dedicated circuit, such as a DSP, programmable logic array, or the like.

Any range or device value given herein may be extended or altered without losing the effect sought, as will be apparent to the skilled person.

It will be understood that the benefits and advantages described above may relate to one embodiment or may relate to several embodiments. It will further be understood that reference to ‘an’ item refer to one or more of those items.

The steps of the methods described herein may be carried out in any suitable order, or simultaneously where appropriate. Additionally, individual blocks may be deleted from any of the methods without departing from the spirit and scope of the subject matter described herein.

It will be understood that the above description of a preferred embodiment is given by way of example only and that various modifications may be made by those skilled in the art. The above specification, examples and data provide a complete description of the structure and use of exemplary embodiments of the invention. Although various embodiments of the invention have been described above with a certain degree of particularity, or with reference to one or more individual embodiments, those skilled in the art could make numerous alterations to the disclosed embodiments without departing from the spirit or scope of this invention.

1. A method comprising:
selecting one of a plurality of channels on which to send one of a collection of data packets the collection comprising a plurality of data packets;
transmitting the data packet on the selected channel and waiting for a first acknowledgement message;
if a first acknowledgement is received, continuing to use the selected channel to transmit packets from the collection and waiting for a second acknowledgement message after transmitting each packet;
if no second acknowledgement is received after transmitting one of the packets, giving up the selected channel on the basis of a specified channel release probability.

2. A method as claimed in claim 1 wherein data from the collection of data packets together forms a data file.

3. A method as claimed in claim 1 which is carried out as part of a communications protocol which provides no channel collision avoidance mechanism.

4. A method as claimed in claim 1 which further comprises, if no first acknowledgement is received, repeating the step of selecting a channel after a substantially random waiting period on the basis of a channel selection attempt probability.

5. A method as claimed in claim 4 wherein the channel release probability is about 0.05 and the channel selection attempt probability is about 0.2.

6. A method as claimed in claim 1 which further comprises repeating the step of selecting one of the plurality of channels such that a second channel is selected and continuing to use both the selected channel and the second selected channel to transmit packets from the collection.

7. A method as claimed in claim 6 which further comprises repeating the step of selecting one of the channels in order to select subsequent channels and continuing to use all the selected channels to transmit packets from the collection.

8. A method as claimed in claim 6 wherein, for each channel being used, the step of selecting each channel is made on the basis of a channel selection attempt probability, that channel selection attempt probability being selected independently and being used to implement a random waiting time.

9. A method as claimed in claim 8 wherein the channel selection attempt probability is selected based on information about collision history.

10. A method as claimed in claim 8 wherein the channel selection attempt probability is increased if a first acknowledgement is received and is decreased by a specified amount if a first acknowledgement is not received within a specified time limit.

11. A method as claimed in claim 10 wherein the channel selection attempt probability is not increased beyond a maximum value and is not decreased beyond a minimum value.

12. A method as claimed in claim 1 which is carried out as part of a communications protocol at a medium access control layer of a suite of communications protocols.

13. A method as claimed in claim 1 which is carried out at a communications terminal in a wireless access communications network.

14. A method as claimed in claim 1 which is carried out as part of a communications protocol which provides a plurality of channels by virtue of a frequency division process.

15. A method as claimed in claim 1 which is carried out as part of a communications protocol which provides a plurality of channels operable in synchronous mode on the basis of specified, fixed length time periods.

16. A method comprising:
selecting one of a plurality of channels on which to send one of a collection of data packets the collection comprising a plurality of data packets;
transmitting the data packet on the selected channel and continuing to use the selected channel to transmit packets from the collection;
waiting for an acknowledgement message after transmitting each packet;
if no acknowledgement is received after transmitting one of the packets, giving up the selected channel on the basis of a specified channel release probability;
the method being carried out as part of a communications protocol which provides no collision avoidance ability.

17. A method as claimed in claim 16 which further comprises repeating the step of selecting one of the plurality of channels such that a second channel is selected and continuing to use both the selected channel and the second selected channel to transmit packets from the collection.

18. A communications network node comprising:
a processor arranged to select one of a plurality of channels on which to send one of a collection of data packets the collection comprising a plurality of data packets;
a transmitter arranged to transmit the data packet on the selected channel and wait for a first acknowledgement message;
and wherein the transmitter is arranged such that if a first acknowledgement is received, the transmitter continues to use the selected channel to transmit packets from the collection and to wait for a second acknowledgment after transmitting each packet;
and wherein the transmitter is also arranged such that if no second acknowledgement is received after transmitting one of the packets, the transmitter gives up the selected channel on the basis of a specified channel release attempt probability.

19. A communications network node as claimed in claim 18 wherein the processor and the transmitter are arranged to behave following a communications protocol which provides no channel collision avoidance mechanism.

20. A communications network node as claimed in claim 18 wherein the processor is arranged to dynamically select the channel selection attempt probability based on information about collision history.
